(19) United States
(12) Patent Application Publication
(10) Pub. No.: US 2010/0265164 A1
(43) Pub. Date: Oct. 21, 2010

(54) IMAGE PROCESSING APPARATUS AND IMAGE PROCESSING METHOD

(75) Inventor: Yasuhiro Okuno, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/741,344

(22) PCT Filed: Nov. 5, 2008
(86) PCT No.: PCT/JP2008/070540

§ 371 Date: May 4, 2010

(30) Foreign Application Priority Data
Nov. 7, 2007 (JP) 2007-289965

(51) Int. Cl. G09G 5/00

(52) U.S. Cl. 345/8

(57) ABSTRACT

The positional relationship among a physical object, virtual object, and viewpoint is calculated using the position information of the physical object, that of the virtual object, and that of the viewpoint, and it is determined whether or not the calculated positional relationship satisfies a predetermined condition (S402). When it is determined that the positional relationship satisfies the predetermined condition, sound data is adjusted to adjust a sound indicated by the sound data (S404), and a sound signal based on the adjusted sound data is generated and output.

### BACKGROUND OF THE INVENTION

1. Field of the Invention

The present invention relates to a technique for presenting an image obtained by superposing a physical space and virtual space to the user.

2. Description of the Related Art

Conventionally, a mixed reality (MR) presentation apparatus is available. For example, an MR presentation apparatus comprises a video display unit, physical video capturing unit, virtual video generation unit, position and orientation detection unit, and video composition unit which composites physical and virtual video images.

The physical video capturing unit is, for example, a compact camera attached to a head mounted display (HMD), and captures a scenery in front of the HMD as a physical video image. The captured physical video image is recorded in a memory of a computer as data.

The position and orientation detection unit is, for example, a position and orientation sensor, which detects the position and orientation of the physical video capturing unit. Note that the position and orientation of the physical video capturing unit can be calculated by a method using magnetism or a method using image processing.

The virtual video generation unit generates a virtual video image by laying out CG images that have undergone three-dimensional (3D) modeling on a virtual space having the same scale as a physical space, and rendering the scene of that virtual space from the same position and orientation as those of the physical video capturing unit.

The video composition unit generates an MR video image by superposing the virtual video image obtained by the virtual video generation unit on the physical video image obtained by the physical video capturing unit. An operation example of the video composition unit includes a control operation for writing a physical video image captured by the physical video capturing unit on a video memory of the computer, and controlling the virtual video generation unit to write a virtual video image on the written physical video image.

When the HMD is of an optical see-through type, the need for the physical video capturing unit can be obviated. The position and orientation detection unit measures the viewpoint position and orientation of the HMD. The video composition unit outputs a virtual video image to the HMD.

By displaying an MR video image obtained in this way on the video display unit of the HMD or the like, a viewer can experience as if virtual objects were appearing on the physical space.

When a virtual object is a “sound source”, 3D sound reproduction can be executed according to the position of the virtual object using a 3D sound reproduction technique as a related art (patent reference 1).

[Patent Reference 1] Japanese Patent Laid-Open No. 05-336599

Conventionally, a sound generated in a scene on the virtual space is presented as a 3D sound, or a virtual sound is modified in consideration of a physical sound environment as if it were sounding on the physical space. However, it is difficult to change a physical sound from a physical sound source by changing the layout of the virtual object and to present the changed physical sound to the viewer. For example, the viewer cannot use a virtual object as a shield on a physical object serving as a sound source so as to shield a physical sound from that sound source.

### SUMMARY OF THE INVENTION

The present invention has been made in consideration of the aforementioned problems, and has as its object to provide a technique for changing a physical sound generated by a physical object serving as a sound source as needed in consideration of the layout position of a virtual object, and presenting the changed sound.

According to the first aspect of the present invention, an image processing apparatus for compositing an image of a physical space and an image of a virtual object, comprises:

a unit which acquires a position of a sound source on the physical space and a position of the virtual object; and

a change unit which changes a sound based on the sound source in accordance with the position of the sound source and the position of the virtual object.

According to the second aspect of the present invention, an image processing method to be executed by an image processing apparatus for compositing an image of a physical space and an image of a virtual object, comprises:

a step of acquiring a position of a sound source on the physical space and a position of the virtual object; and

a step of changing a sound based on the sound source in accordance with the position of the sound source and the position of the virtual object.

According to the third aspect of the present invention, an image processing apparatus which comprises:

a unit which generates an image of a virtual space configured by a virtual object, the image of the virtual space being adapted to be superposed on a physical space on which a physical object serving as a sound source is laid out,

a unit which outputs the image of the virtual space,

an acquisition unit which acquires a sound produced by the physical object as sound data, and

an output unit which generates a sound signal based on the sound data acquired by the acquisition unit, and outputs the generated sound signal to a sound output device,

the apparatus comprises:

a unit which acquires position information of the physical object;

a unit which acquires position information of the virtual object;

a unit which acquires position information of a viewpoint of a user;

a determination unit which calculates a positional relationship among the physical object, the virtual object, and the viewpoint using the position information of the physical object, the position information of the virtual object, and the position information of the viewpoint, and determines whether or not the calculated positional relationship satisfies a predetermined condition; and

a control unit which controls, when the determination unit determines that the positional relationship satisfies the predetermined condition, the output unit to adjust the sound data so as to adjust a sound indicated by the sound data acquired by the acquisition unit, and to generate and output a sound signal based on the adjusted sound data.

According to the fourth aspect of the present invention, an image processing method to be executed by an image processing apparatus, which comprises

a unit which generates an image of a virtual space configured by a virtual object, the image of the virtual space being to be superposed on a physical space on which a physical object serving as a sound source is laid out,

a unit which outputs the image of the virtual space,

an acquisition unit which acquires a sound produced by the physical object as sound data, and an output unit which generates a sound signal based on the sound data acquired by the acquisition unit, and outputs the generated sound signal to a sound output device,

the method comprises:

a step of acquiring position information of the physical object;

a step of acquiring position information of the virtual object;

a step of acquiring position information of a viewpoint of a user;

a determination step of calculating a positional relationship among the physical object, the virtual object, and the viewpoint using the position information of the physical object, the position information of the virtual object, and the position information of the viewpoint, and determining whether or not the calculated positional relationship satisfies a predetermined condition; and

a control step of controlling, when it is determined in the determination step that the positional relationship satisfies the predetermined condition, the output unit to adjust the sound data so as to adjust a sound indicated by the sound data acquired by the acquisition unit, and to generate and output a sound signal based on the adjusted sound data.

Further features of the present invention will become apparent from the following description of exemplary embodiments with reference to the attached drawings.

### BRIEF DESCRIPTION OF THE DRAWINGS

FIG. 1 is a block diagram showing an example of the hardware arrangement of a system according to the first embodiment of the present invention;

FIG. 2 is a flowchart of main processing executed by a computer 100;

FIG. 3 is a flowchart showing details of the processing in step S205;

FIG. 4 is a flowchart showing details of the processing in step S302; and

FIG. 5 is a view showing a state of a physical space assumed upon execution of the processing according to the flowchart of FIG. 4.

### DESCRIPTION OF THE EMBODIMENTS

Preferred embodiments of the present invention will be described in detail hereinafter with reference to the accompanying drawings. Note that these embodiments will be explained as examples of the preferred arrangement of the invention described in the scope of the claims, and the invention is not limited to the embodiments to be described hereinafter.

### First Embodiment

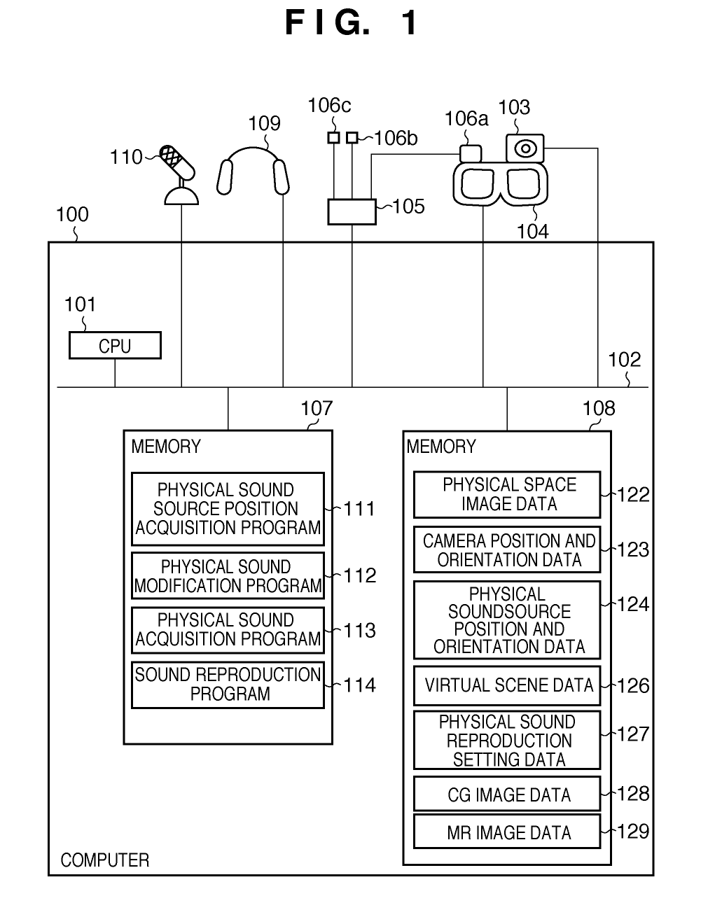

FIG. 1 is a block diagram showing an example of the hardware arrangement of a system according to this embodiment. As shown in FIG. 1, the system according to this embodiment comprises a computer 100, microphone 110, headphone 109, sensor controller 105, position and orientation sensors 106a to 106c, HMD 104, and video camera 103.

The microphone 110 will be described first. As is well known, the microphone 110 is used to collect a surrounding sound, and a signal indicating the collected sound is converted into sound data and is input to the computer 100. The microphone 110 may be laid out at a predetermined position on a physical space or may be laid out on a “physical object that produces a sound (a physical object serving as a sound source)” (on the physical object) laid out on the physical space.

The headphone 109 will be explained below.

As is well known, the headphone 109 is a sound output device which covers the ears of the user and supplies a sound to the ears. In this embodiment, the headphone 109 is not particularly limited as long as it can supply not a sound on the physical space but only a sound according to sound data supplied from the computer 100. For example, a headphone having a known noise cancel function may be used. As is well known, the noise cancel function prevents the user who wears the headphone from hearing any sound on the physical noise, and can realize shielding of a sound better than that obtained by simple sound isolation. In this embodiment, a sound input from the microphone 110 to the computer 100 is normally output intact to the headphone 109. However, as will be described later, when the positional relationship among the user's viewpoint, the physical object serving as a sound source, and a virtual object satisfies a predetermined condition, the computer 100 adjusts a sound collected by the microphone 110, and outputs the adjusted sound to the headphone 109.

The HMD 104 will be described below.

The video camera 103 and the position and orientation sensor 106a are attached to the HMD 104. The video camera 103 is used to capture a movie of the physical space, and sequentially outputs captured frame images (physical space images) to the computer 100. When the HMD 104 has an arrangement that allows stereoscopic view, the video cameras 103 may be attached one each to the right and left positions on the HMD 104.

The position and orientation sensor 106a is used to measure the position and orientation of itself, and outputs the measurement results to the sensor controller 105 as signals. The sensor controller 105 calculates position and orientation information of the position and orientation sensor 106a based on the signals received from the position and orientation sensor 106a, and outputs the calculated position and orientation information to the computer 100.

Note that the position and orientation sensors 106b and 106c are further connected to the sensor controller 105. The position and orientation sensor 106b is attached to the physical object that produces a sound (the physical object serving as the sound source), and the position and orientation sensor 106c is laid out at a predetermined position on the physical space or is held by the hand of the user. The position and orientation sensors 106b and 106c measure the positions and orientations of themselves as in the position and orientation sensor 106a. The position and orientation sensors 106b and 106c respectively output the measurement results to the sensor controller 105 as signals. The sensor controller 105 calculates position and orientation information of the position and orientation sensors 106b and 106c based on the signals received from the position and orientation sensors 106b and 106c, and outputs the calculated position and orientation information to the computer 100.

Note that a sensor system configured by the position and orientation sensors 106a to 106c and the sensor controller 105 can use various sensor systems such as a magnetic sensor, optical sensor, and the like. Since the technique for acquiring the position and orientation information of a target object using a sensor is known to those who are skilled in the art, a description thereof will not be given.

As is well known, the HMD 104 has a display screen, which is located in front of the eyes of the user who wears the HMD 104 on the head.

The computer 100 will be described below. The computer 100 has a CPU 101 and memories 107 and 108, which are connected to a bus 102. Note that the illustrated components of the computer 100 shown in FIG. 1 are those used in the following description, and the computer 100 is not configured by only these components.

The CPU 101 executes respective processes as those to be implemented by the computer 100 using programs 111 to 114 stored in the memory 107 and data 122 to 129 stored in the memory 108.

The memory 107 stores the programs 111 to 114, which are to be processed by the CPU 101.

The memory 108 stores the data 122 to 129, which are to be processed by the CPU 101.

Note that the information stored in each of these memories 107 and 108 is not limited to this, and given information described in the following description, and information which would be naturally used by those who are skilled in the art and require no special explanation are stored. Allocations of information to be stored in the memories 107 and 108 are not limited to those shown in FIG. 1. The memories 107 and 108 need not be used as independent memories but they may be used as a single memory.

The programs 111 to 114 and data 122 to 129 will be described later.

In FIG. 1, the microphone 110, headphone 109, sensor controller 105, HMD 104, and video camera 103 are directly connected to the bus 102. However, in practice, these devices are connected to the bus 102 via I/Fs (interfaces) (not shown).

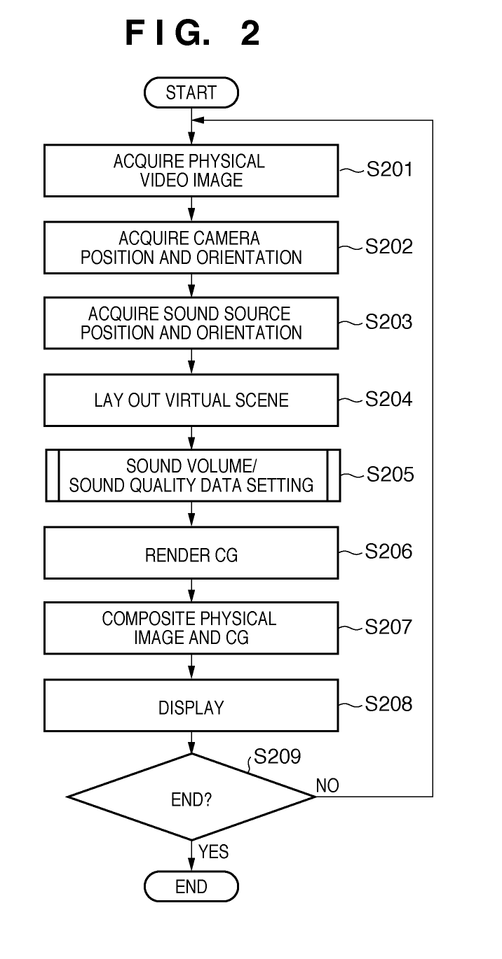

The processing to be executed by the computer 100 will be described below with reference to FIGS. 2 to 4 that show the flowcharts of the processing. Note that a main body that executes the processing according to these flowcharts is the CPU 101 unless otherwise specified in the following description.

FIG. 2 is a flowchart of main processing executed by the computer 100.

Referring to FIG. 2, the CPU 101 acquires a physical space image (physical video image) output from the video camera 103, and stores it as physical space image data 122 in the memory 108 in step S201.

In step S202, the CPU 101 acquires the position and orientation information of the position and orientation sensor 106a, which is output from the sensor controller 105. The CPU 101 calculates position and orientation information of the video camera 103 (viewpoint) by adding relationship information indicating the position and orientation relationship between the video camera 103 and position and orientation sensor 106a to the acquired position and orientation information. The CPU 101 stores the calculated position and orientation information of the viewpoint in the memory 108 as camera position and orientation data 123.

In step S203, the CPU 101 executes a physical sound source position acquisition program 111 stored in the memory 107. As a result, the CPU 101 acquires the position and orientation information of the position and orientation sensor 106b, which is output from the sensor controller 105, i.e., that of a physical object serving as a sound source. The CPU 101 stores the acquired position and orientation information of the physical object serving as the sound source in the memory 108 as physical sound source position and orientation data 124.

In step S204, the CPU 101 reads out virtual scene data 126 stored in the memory 108, and creates a virtual space based on the readout virtual scene data 126. The virtual scene data 126 includes data of layout positions and orientations (position information and orientation information) of virtual objects which form the virtual space, the types of light sources laid out on the virtual space, the irradiation directions of light, colors of light, and the like. Furthermore, the virtual scene data 126 includes shape information of the virtual objects. For example, when each virtual object is configured by polygons, the shape information includes normal vector data of the polygons, attributes and colors of the polygons, coordinate value data of vertices that configure the polygons, texture map data, and the like. Therefore, by creating the virtual space based on the virtual scene data 126, virtual objects can be laid out on the virtual space. Assume that a virtual object associated with the position and orientation sensor 106c is laid out on the virtual space to have the position and orientation of the position and orientation sensor 106c. In this case, the virtual object associated with the position and orientation sensor 106c is laid out at the position and orientation indicated by the position and orientation information of the position and orientation sensor 106c, which is output from the sensor controller 105.

In step S205, the CPU 101 executes a physical sound acquisition program 113 stored in the memory 107. As a result, the CPU 101 acquires sound data output from the microphone 110.

The CPU 101 then executes a physical sound modification program 112. As a result, the CPU 101 calculates the positional relationship among the physical object, virtual objects, and viewpoint using the pieces of position information of the physical object, virtual objects, and viewpoint. The CPU 101 determines whether or not the calculated positional relationship satisfies a predetermined condition. If it is determined that the positional relationship satisfies the predetermined condition, the CPU 101 adjusts the sound data acquired in step S205. That is, the CPU 101 manipulates the sound volume and quality of a sound indicated by that sound data based on these pieces of position information. The CPU 101 stores the adjusted sound data in the memory 108 as physical sound reproduction setting data 127. The CPU 101 executes a sound reproduction program 114. As a result, the CPU 101 outputs a sound signal based on the physical sound reproduction setting data 127 stored in the memory 108 to the headphone 109. Details of the processing in step S205 will be described later.

In step S206, the CPU 101 lays out the viewpoint having the position and orientation indicated by the camera position and orientation data 123 stored in the memory 108 in step S202 on the virtual space created in step S204. The CPU 101 then generates an image of the virtual space (virtual space image) viewable from that viewpoint. The CPU 101 stores the generated virtual space image in the memory 108 as CG image data 128.

In step S207, the CPU 101 superposes the virtual space image indicated by the CG image data 128 stored in the memory 108 in step S206 on the physical space image indicated by the physical space image data 122 stored in the memory 108 in step S201. Note that various techniques for superposing a virtual space image on a physical space image are available, and any of such techniques may be used in this embodiment. The CPU 101 stores the generated composite image (a superposed image generated by superposing the virtual space image on the physical space image) in the memory 108 as MR image data 129.

In step S208, the CPU 101 outputs the MR image data 129 stored in the memory 108 in step S207 to the HMD 104 as a video signal. As a result, the composite image is displayed in front of the eyes of the user who wears the HMD 104 on the head.

If the CPU 101 detects an instruction to end this processing input from an operation unit (not shown) or detects that a condition required to end this processing is satisfied, it ends the processing via step S209. On the other hand, if the CPU 101 does not detect anything, the process returns to step S201 via step S209, and the CPU 101 executes the processes in step S201 and subsequent steps so as to present a composite image of the next frame to the user.

The processing in step S205 will be described below.

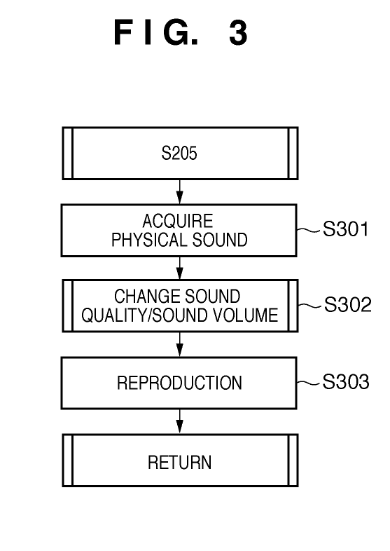

FIG. 3 is a flowchart showing details of the processing in step S205.

In step S301, the CPU 101 executes the physical sound acquisition program 113 stored in the memory 107. As a result, the CPU 101 acquires sound data output from the microphone 110. As described above, the microphone 110 may be laid out on the “physical object that produces a sound (the physical object serving as the sound source)” (on the physical object). However, in this case, the microphone 110 is preferably attached to a neighboring position of the position and orientation sensor 106b, so that the position and orientation of the microphone 110 become nearly the same as those measured by the position and orientation sensor 106b. Furthermore, the microphone 110 may be attached to the user such as the ear of the user who wears the HMD 104 on the head. The format of sound data input from the microphone 110 to the computer 100 is that which can be handled by the computer 100, as a matter of course.

In step S302, the CPU 101 executes the physical sound modification program 112. As a result, the CPU 101 calculates the positional relationship among the physical object, virtual objects, and viewpoint using the pieces of position information of the physical object serving as the sound source, the virtual object, and the viewpoint. The CPU 101 determines whether or not the calculated positional relationship satisfies a predetermined condition. If it is determined that the positional relationship satisfies the predetermined condition, the CPU 101 adjusts the sound data acquired in step S301. That is, the CPU 101 manipulates the sound volume and quality of a sound indicated by that sound data based on these pieces of position information. The CPU 101 stores the adjusted sound data in the memory 108 as the physical sound reproduction setting data 127. Details of the processing in step S302 will be described later.

In step S303, the CPU 101 executes the sound reproduction program 114. As a result, the CPU 101 outputs a sound signal based on the physical sound reproduction setting data 127 stored in the memory 108 in step S302 to the headphone 109. When other sounds are to be produced (e.g., a virtual object produces a sound), the CPU 101 generates sound signals based on data of these sounds, and outputs a mixed signal obtained by mixing the generated sound signals and that based on the physical sound reproduction setting data 127 to the headphone 109.

The CPU 101 ends the processing according to the flowchart shown in FIG. 3, and returns to step S206 shown in FIG. 2.

Details of the processing in step S302 will be described below.

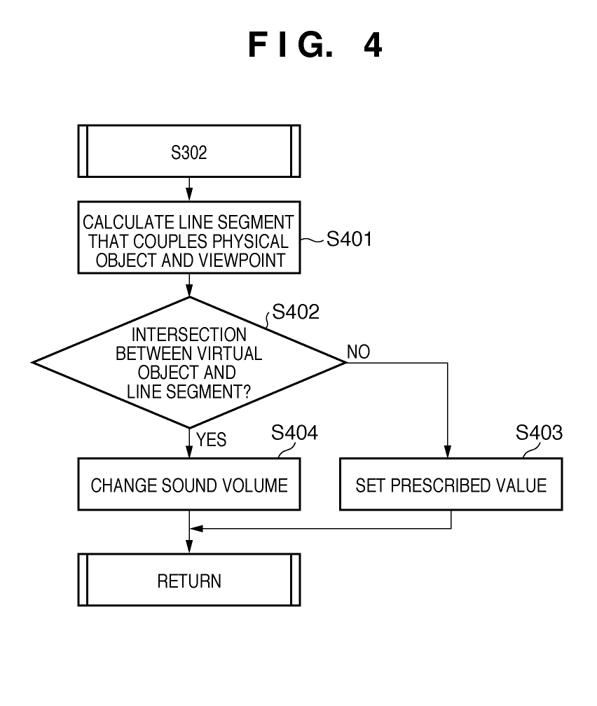

FIG. 4 is a flowchart showing details of the processing in step S302. The processing of the flowchart shown in FIG. 4 is an example of a series of processes for determining whether or not the positional relationship among the physical object serving as the sound source, virtual objects, and viewpoint satisfies the predetermined relationship, and adjusting sound data when it is determined that the positional relationship satisfies the predetermined condition. That is, in the processing of the flowchart shown in FIG. 4, the CPU 101 determines whether or not one or more intersections between a line segment that couples the position of the physical object serving as the sound source and that of the viewpoint, and the virtual objects exist. As a result of this determination process, if one or more intersections exist, the CPU 101 determines that a sound generated by that physical object is shielded by the virtual objects. In this case, the CPU 101 adjusts the sound data to lower the volume (sound volume) of a sound indicated by the sound data acquired from the microphone 110.

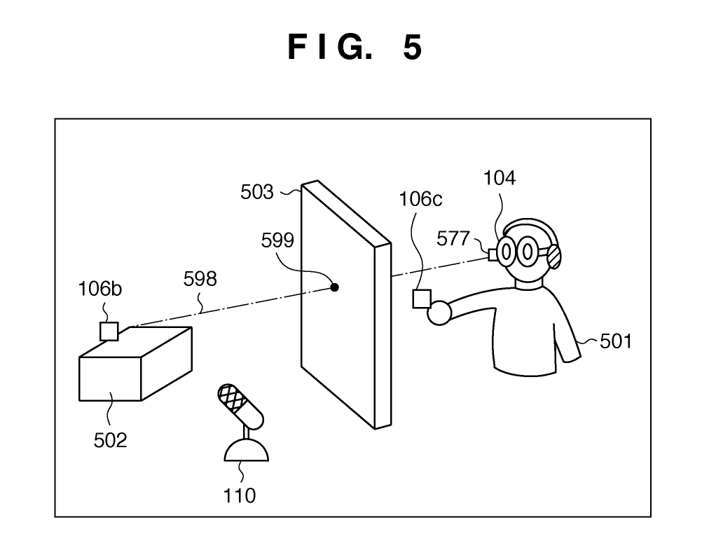

FIG. 5 is a view showing the physical space assumed upon execution of the processing according to the flowchart of FIG. 4. In FIG. 5, the position and orientation sensor 106b is laid out on a physical object 502 serving as a sound source. Therefore, the position and orientation measured by the position and orientation sensor 106b are those of the position and orientation sensor 106b itself, and are also those of the physical object 502. The microphone 110 is laid out at a predetermined position (where it can collect a sound generated by the physical object 502) on the physical space. Of course, the microphone 110 may be laid out on the physical object 502.

A user 501 holds the position and orientation sensor 106c in hand.

Reference numeral 503 denotes a planar virtual object, which is laid out at the position and orientation measured by the position and orientation sensor 106c (FIG. 5 illustrates the position and orientation sensor 106c and virtual object 503 to deviate from each other so as to illustrate both the virtual object 503 and position and orientation sensor 106c). That is, when the user moves the hand that holds the position and orientation sensor 106c, the position and orientation of the position and orientation sensor 106c also change, and those of the virtual object 503 change accordingly. As a result, the user 501 can manipulate the position and orientation of the virtual object 503.

In FIG. 5, a line segment 598 which couples the position of the physical object 502 (that is, the position measured by the position and orientation sensor 106b) and a position 577 of the viewpoint intersect with the virtual object 503 at an intersection 599. In this case, the computer 100 determines that a sound generated by the physical object 502 is shielded by the virtual object 503. The computer 100 then adjusts sound data to lower the volume (sound volume) of the sound data acquired from the microphone 110. The computer 100 outputs a sound signal based on the adjusted sound data to the headphone 109. As a result, the user 501 who wears the headphone 109 can experience “the sensation of the volume of the audible sound lowering as a sound given from the physical object 502 is shielded by the virtual object 503”.

When the user 501 further moves his or her hand and the intersection 599 disappears, the computer 100 does not apply any adjustment processing to the sound data, and outputs a sound signal based on that sound data to the headphone 109. As a result, the user 501 who wears the headphone 109 can experience the sensation of the volume of the audible sound resuming as the sound generated by the physical object 502 is no longer shielded by the virtual object 503.

Referring to FIG. 4, in step S401 the CPU 101 acquires position information from the position and orientation information of the physical object serving as the sound source acquired in step S203. Furthermore, the CPU 101 acquires position information from the position and orientation information of the viewpoint acquired in step S202. The CPU 101 then calculates a line segment that couples a position indicated by the position information of the physical object serving as the sound source, and a position indicated by the position information of the viewpoint.

The CPU 101 checks in step S402 if the line segment calculated in step S401 intersects with each of one or more virtual objects laid out in step S204, so as to determine the presence/absence of intersections with the line segment. In this embodiment, assume that the number of virtual objects to be laid out on the virtual space is one, for the sake of simplicity.

As a result of the process in step S402, if the virtual object laid out on the virtual space intersects with the line segment calculated in step S401, the process advances to step S404. On the other hand, if the virtual object does not intersect with the line segment, the process advances to step S403.

In step S403, the CPU 101 may convert the sound data acquired from the microphone 110 into a sound signal intact without adjusting it, and may output the sound signal to the headphone 109. However, in FIG. 4, the CPU 101 adjusts this sound data to set the volume of a sound indicated by the sound data acquired from the microphone 110 to that of a prescribed value. Since a technique for increasing or decreasing the volume by adjusting sound data is known to those who are skilled in the art, a description thereof will not be given. The process then returns to step S303 in FIG. 3. As a result, a sound signal can be generated based on the adjusted sound data, and that sound signal can be output to the headphone 109.

On the other hand, in step S404 the CPU 101 adjusts this sound data so as to lower the volume (sound volume) of a sound indicated by the sound data acquired from the microphone 110 by a predetermined amount. The process then returns to step S303 in FIG. 3. As a result, a sound signal can be generated based on the adjusted sound data, and that sound signal can be output to the headphone 109.

With the aforementioned processing, when it is determined that a sound generated by the physical object serving as the sound source is shielded by the virtual object, that sound is presented to the user after its volume is lowered. As a result, the user can feel as if the virtual object were shielding the sound.

Note that, in this embodiment, if the line segment which passes through the position of the physical object serving as the sound source and that of the viewpoint intersects with the virtual object is checked. Instead, whether or not a region of a predetermined size having that line segment as an axis partially or fully includes the virtual object may be determined. If it is determined that the region includes the virtual object, the processing in step S404 is executed. On the other hand, if it is determined that the region does not include the virtual object, the processing in step S403 is executed.

In this embodiment, whether or not an intersection exists is simply checked regardless of the location of the intersection on the virtual object surface. However, the amount of lowering the volume may be varied in accordance with the position of the intersection on the virtual object. In this case, for example, the surface of the virtual object is divided into a plurality of regions, and amounts of lowering the volume are set for the respective divided regions. Then, by specifying which of the divided regions the intersection is located, the volume is lowered by an amount corresponding to the specified divided region. Also, the amount of lowering the volume may be changed depending on whether or not the region of the virtual object includes the physical object serving as the sound source.

Alternatively, material information indicating the material of the virtual object may be referred to, and the amount of lowering the volume may be varied based on the material information which is referred to. For example, when the material information at the intersection assumes a numerical value indicating high hardness of the material, the amount of lowering the volume is increased. Conversely, when the material information at the intersection assumes a numerical value indicating low hardness of the material, the amount of lowering the volume is decreased.

In this embodiment, the volume of a sound indicated by sound data is manipulated as an example of adjustment of sound data. However, in this embodiment, other elements of a sound may be changed. For example, a sound indicated by sound data acquired from the microphone 110 may be filtered (equalized) in association with its frequency. For example, only low-frequency components may be reduced, or only high-frequency components may be reduced.

Also, material information indicating the material of the virtual object may be referred to, and the sound data may be adjusted to change the sound quality of a sound indicated by that sound data based on the material information, which is referred to.

This embodiment has exemplified the case in which the virtual object shields a sound generated by the physical object serving as the sound source. However, when a virtual object that simulates a megaphone is located between the physical object serving as the sound source and the viewpoint (assume that a part of the virtual object corresponding to a mouthpiece of the megaphone is directed toward the physical object serving as the sound source), the volume of a sound indicated by the sound data may be increased.

When the position of the physical object serving as the sound source is unknown, but the direction from the viewpoint to the physical object serving as the sound source is known, a line may be extended in that direction to check if that line and the virtual object intersect. When the virtual object is located behind the physical object serving as the sound source, a precise solution cannot be obtained. However, under a specific condition (i.e., under the assumption that the virtual object is always located near the user, and the physical object serving as the sound source is not located between the virtual object and user), a method of detecting only the azimuth of the sound source from the user can be used.

In this embodiment, the HMD 104 of the video see-through type is used. However, an HMD of an optical see-through type may be used. In this case, transmission of a sound signal to the HMD 104 remains the same, but that of an image to the HMD 104 is slightly different from the above description. That is, when the HMD 104 is of the optical see-through type, only a virtual space image is transmitted to the HMD 104.

In order to acquire the position and orientation information of the video camera 103, a method other than the position and orientation acquisition method using the sensor system may be used. For example, a method of laying out indices on the physical space, and calculating the position and orientation information of the video camera 103 using an image obtained by capturing that physical space by the video camera 103 may be used. This method is a state-of-the-art technique.

The position information of the physical object serving as the sound source may be acquired using a microphone array in place of the position and orientation sensor attached to the physical object.

### Second Embodiment

In the description of the first embodiment, the number of physical objects serving as sound sources is one. However, even when a plurality of physical objects serving as sound sources are laid out on the physical space, the first embodiment can be applied to each individual physical object.

That is, microphones 110 and position and orientation sensors 106c are provided to the respective physical objects serving as sound sources. The computer 100 executes the processing described in the first embodiment for each physical object, and finally mixes sounds collected from the respective physical objects, thus outputting the mixed sound to the headphone 109.

In case of this embodiment, sound acquisition and position acquisition of sound sources are simultaneously executed. That is, a system like a microphone array which can simultaneously implement position estimation of a plurality of sound sources and sound isolation may be used.

### Other Embodiments

The objects of the present invention can be achieved as follows. That is, a recording medium (or storage medium) that records program codes of software required to implement the functions of the aforementioned embodiments is supplied to a system or apparatus. That storage medium is a computer-readable storage medium, needless to say. A computer (or a CPU or MPU) of that system or apparatus reads out and executes the program codes stored in the recording medium. In this case, the program codes themselves read out from the recording medium implement the functions of the aforementioned embodiments, and the recording medium that records the program codes constitutes the present invention.

When the computer executes the readout program codes, an operating system (OS) or the like, which runs on the computer, executes some or all of actual processes based on instructions of these program codes. The present invention also includes a case in which the functions of the aforementioned embodiments are implemented by these processes.

Furthermore, assume that the program codes read out from the recording medium are written in a memory equipped on a function expansion card or function expansion unit which is inserted in or connected to the computer. After that, a CPU or the like equipped on the function expansion card or unit executes some or all of actual processes based on instructions of these program codes, thereby implementing the functions of the aforementioned embodiments.

When the present invention is applied to the recording medium, that recording medium stores program codes corresponding to the aforementioned flowcharts.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-289965 filed Nov. 7, 2007 which is hereby incorporated by reference herein in its entirety.

What is claimed is:

1. An image processing apparatus for compositing an image of a physical space and an image of a virtual object, comprising:
a unit which acquires a position of a sound source on the physical space and a position of the virtual object; and
a change unit which changes a sound based on the sound source in accordance with the position of the sound source and the position of the virtual object.

2. The apparatus according to claim 1, further comprising a unit which acquires position information indicating a position of a viewpoint of a user,
wherein said change unit changes the sound based on the sound source in accordance with a distance between a line that couples the position of the sound source and the position of the viewpoint, and the position of the virtual object.

3. The apparatus according to claim 1, further comprising a unit which acquires position information indicating a position of a viewpoint of a user,
wherein said change unit changes the sound based on the sound source in accordance with a position of an intersection between a line that couples the position of the sound source and the position of the viewpoint, and a surface of the virtual object.

4. The apparatus according to claim 3, wherein lowering amounts of the sound based on the sound source are set in correspondence with a plurality of regions of the virtual object, and
said change unit changes the sound based on the sound source in accordance with the lowering amount set for the region where the intersection exists.

5. An image processing method to be executed by an image processing apparatus for compositing an image of a physical space and an image of a virtual object, comprising:
a step of acquiring a position of a sound source on the physical space and a position of the virtual object; and
a step of changing a sound based on the sound source in accordance with the position of the sound source and the position of the virtual object.

6. A computer-readable storage medium storing a computer program for making a computer execute an image processing method according to claim 5.

7. An image processing apparatus which comprises
a unit which generates an image of a virtual space configured by a virtual object, the image of the virtual space being adapted to be superposed on a physical space on which a physical object serving as a sound source is laid out,
a unit which outputs the image of the virtual space,
an acquisition unit which acquires a sound produced by the physical object as sound data, and
an output unit which generates a sound signal based on the sound data acquired by said acquisition unit, and outputs the generated sound signal to a sound output device,
said apparatus comprising:
a unit which acquires position information of the physical object;
a unit which acquires position information of the virtual object;
a unit which acquires position information of a viewpoint of a user;
a determination unit which calculates a positional relationship among the physical object, the virtual object, and the viewpoint using the position information of the physical object, the position information of the virtual object, and the position information of the viewpoint, and determines whether or not the calculated positional relationship satisfies a predetermined condition; and
a control unit which controls, when said determination unit determines that the positional relationship satisfies the predetermined condition, said output unit to adjust the sound data so as to adjust a sound indicated by the sound data acquired by said acquisition unit, and to generate and output a sound signal based on the adjusted sound data.

8. The apparatus according to claim 7, wherein said determination unit comprises:
a unit which calculates a line segment that couples a position indicated by the position information of the physical object and a position indicated by the position information of the viewpoint; and
a unit which determines whether or not a region having the line segment as an axis includes a part or all of the virtual object.

9. The apparatus according to claim 8, wherein when said determination unit determines that the region having the line segment as the axis includes a part or all of the virtual object,
said control unit controls said output unit to adjust the sound data so as to lower a volume of a sound indicated by the sound data acquired by said acquisition unit, and to generate and output a sound signal based on the adjusted sound data.

10. The apparatus according to claim 7, wherein said control unit further refers to material information of the virtual object, and controls said output unit based on the material information, which is referred to, to adjust the sound data so as to change sound quality of a sound indicated by the sound data acquired by said acquisition unit, and to generate and output a sound signal based on the adjusted sound data.

11. The apparatus according to claim 7, wherein said determination unit comprises:
a unit which calculates a line segment that couples a position indicated by the position information of the physical object and a position indicated by the position information of the viewpoint; and
a unit which determines whether or not an intersection exists between the line segment and the virtual object.

12. The apparatus according to claim 11, wherein when said determination unit determines that an intersection exists between the line segment and the virtual object,
said control unit controls said output unit to adjust the sound data so as to lower a volume of a sound indicated by the sound data acquired by said acquisition unit, and to generate and output a sound signal based on the adjusted sound data.

13. The apparatus according to claim 12, wherein said control unit further changes an amount of lowering the volume in accordance with a position of the intersection on the virtual object.

14. The apparatus according to claim 7, wherein said acquisition unit acquires a sound produced by the physical object from a microphone laid out on the physical object as sound data.

15. The apparatus according to claim 7, wherein the sound output device is a headphone, which has a function of preventing a user who wears the headphone from hearing a sound on the physical space.

16. An image processing method to be executed by an image processing apparatus, which comprises
a unit which generates an image of a virtual space configured by a virtual object, the image of the virtual space being to be superposed on a physical space on which a physical object serving as a sound source is laid out,
a unit which outputs the image of the virtual space,
an acquisition unit which acquires a sound produced by the physical object as sound data, and
an output unit which generates a sound signal based on the sound data acquired by said acquisition unit, and outputs the generated sound signal to a sound output device,
said method comprising:
a step of acquiring position information of the physical object;
a step of acquiring position information of the virtual object;
a step of acquiring position information of a viewpoint of a user;
a determination step of calculating a positional relationship among the physical object, the virtual object, and the viewpoint using the position information of the physical object, the position information of the virtual object, and the position information of the viewpoint, and determining whether or not the calculated positional relationship satisfies a predetermined condition; and
a control step of controlling, when it is determined in the determination step that the positional relationship satisfies the predetermined condition, said output unit to adjust the sound data so as to adjust a sound indicated by the sound data acquired by said acquisition unit, and to generate and output a sound signal based on the adjusted sound data.

17. A computer-readable storage medium storing a computer program for making a computer execute an image processing method according to claim 16.
